(19) United States
(12) Patent Application Publication
(10) Pub. No.: US 2014/0359501 A1
(43) Pub. Date: Dec. 4, 2014

(54) METHOD AND DEVICE FOR CONFIGURING VISUALIZATION OF A WEB BROWSER

(71) Applicant: Tencent Technology (Shenzhen) Company Limited, Shenzhen (CN)

(72) Inventor: Lei ZHANG, Shenzhen (CN)

(21) Appl. No.: 14/458,117

(22) Filed: Aug. 12, 2014

Related U.S. Application Data
(63) Continuation of application No. PCT/CN2014/077972, filed on May 21, 2014.

(30) Foreign Application Priority Data
Jun. 4, 2013 (CN) 201310217792.3

(51) Int. Cl. G06F 3/0481; G06F 3/0484

(52) U.S. Cl. CPC G06F 3/04817; G06F 3/04842
USPC 715/765

(57) ABSTRACT

A method is performed at a mobile device for configuring visualization of an application running on the mobile device. The mobile device displays an application on its display, the application including a content display region and a visualization control icon at a default dimension. Upon detecting a user selection of the visualization control icon, the mobile device expands the visualization control icon into the content display region. The expanded visualization control icon includes a region for receiving one or more user instructions. The mobile device updates the visualization of the content display region in accordance with the user instructions and reduces the expanded visualization control icon to its default dimension.

### RELATED APPLICATIONS

This application is a continuation application of PCT Patent Application No. PCT/CN2014/077972, entitled “METHOD AND DEVICE FOR CONFIGURING VISUALIZATION OF A WEB BROWSER” filed on May 21, 2014, which claims priority to Chinese Patent Application No. 201310217792.3, “METHOD AND DEVICE FOR CONFIGURING VISUALIZATION OF A WEB BROWSER,” filed on Jun. 4, 2013, both of which are hereby incorporated by reference in their entirety.

### TECHNICAL FIELD

The present application relates to the electronic technology field, specifically relates to method and device for configuring visualization of a web browser on a mobile device's display.

### BACKGROUND

When the user uses the browser to browse webpage or multi-media file, it usually needs to adjust the display configuration such as brightness and contrast, etc. of the screen according to the light intensity of the surrounding environment, so as to be suitable for the human eye. In the dark environment, the user will lower the brightness and contrast of the screen, because when the external light is relatively dark, the over bright screen will make people feel dazzling; In the strong light environment, the user will rise the brightness and contrast of the screen, by setting the display configuration, it can not only improve the comfort level of human eye to watch, but also play the role of protecting eyesight. At present, the entrance of the setting mode of display configuration provided by the mobile device browser is generally deep; the user often needs to click for several times to access the setting interface to set the display configuration. Many users even don't know or can't find the setting entrance; it brings much trouble for the usage of browser.

### SUMMARY

The above deficiencies and other problems associated with the conventional approach of configuring the visualization of an application on a mobile device are reduced or eliminated by the present application disclosed below. In some embodiments, the present application is implemented in a computer system that has one or more processors, memory and one or more modules, programs or sets of instructions stored in the memory for performing multiple functions. Instructions for performing these functions may be included in a computer program product configured for execution by one or more processors.

One aspect of the present application involves a computer-implemented method performed by a mobile device having one or more processors and memory and a display. The computer-implemented method includes: displaying an application on the display, the application including a content display region and a visualization control icon at a default dimension; detecting a user selection of the visualization control icon; in response to detecting the user selection: expanding the visualization control icon into the content display region, the expanded visualization control icon including a region for receiving one or more user instructions; updating the visualization of the content display region in accordance with the user instructions; and reducing the expanded visualization control icon to its default dimension.

Another aspect of the present application involves a mobile device including memory, one or more processors, and one or more programs stored in the memory and configured for execution by the one or more processors. The one or more programs include instructions for: displaying an application on the display, the application including a content display region and a visualization control icon at a default dimension; detecting a user selection of the visualization control icon; in response to detecting the user selection: expanding the visualization control icon into the content display region, the expanded visualization control icon including a region for receiving one or more user instructions; updating the visualization of the content display region in accordance with the user instructions; and reducing the expanded visualization control icon to its default dimension.

Another aspect of the present application involves a non-transitory computer readable storage medium having stored therein one or more programs for execution by one or more processors of a computer system, the one or more programs including instructions for: displaying an application on the display, the application including a content display region and a visualization control icon at a default dimension; detecting a user selection of the visualization control icon; in response to detecting the user selection: expanding the visualization control icon into the content display region, the expanded visualization control icon including a region for receiving one or more user instructions; updating the visualization of the content display region in accordance with the user instructions; and reducing the expanded visualization control icon to its default dimension.

### BRIEF DESCRIPTION OF THE DRAWINGS

The aforementioned features and advantages of the present application as well as additional features and advantages thereof will be more clearly understood hereinafter as a result of a detailed description of preferred embodiments when taken in conjunction with the drawings.

In order to explain the embodiment of the present application and the technical scheme of conventional technology more clearly, the following will briefly introduce the necessary drawings described in the embodiment or conventional technology, obviously, the drawings in the following description are only some embodiments of the present application, for the common technicians of this field, they can also obtain other drawings according to these drawings without any creative labor.

FIG. 1 is the schematic flow diagram of browser display setting method provided by the embodiment of the present application;

FIG. 2 is the schematic state diagram of browser sidebar when it is refracted provided by the embodiment of the present application;

FIG. 3 is the schematic flow diagram of browser display setting method provided by another embodiment of the present application;

FIG. 4 is the diagram of slider configured in the sidebar of browser provided by the embodiment of the present application;

FIG. 5 is the schematic flow diagram of browser display setting method provided by another embodiment of the present application;

FIG. 6 is the schematic diagram showing the structure of a browser display setting device provided by the embodiment of the present application;

FIG. 7 is the schematic diagram showing the structure of operation obtaining module provided by the embodiment of the present application;

FIG. 8 is the schematic diagram showing the structure of display setting module provided by the embodiment of the present application; and

FIG. 9 is a block diagram illustrating components of a mobile device with a touch-sensitive display system in accordance with some embodiments of the present application.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

In the following, combined with the attached drawings of the embodiment of the present application, the technical scheme of the embodiment of the present application will be described clearly and entirely, obviously, the described embodiments are only some of the embodiments, not all of them. Based on the embodiment of the present application, all the other embodiments obtained by the common technicians of this field without any creative labor belong to the protective scope of the present application.

The browser display setting method and device provided by the embodiment of the present application can be realized in the mobile device devices including tablets, mobile phone, smart phone, laptop, etc., the user can browse the webpage or multi-media file through the browser in the aforementioned mobile device devices.

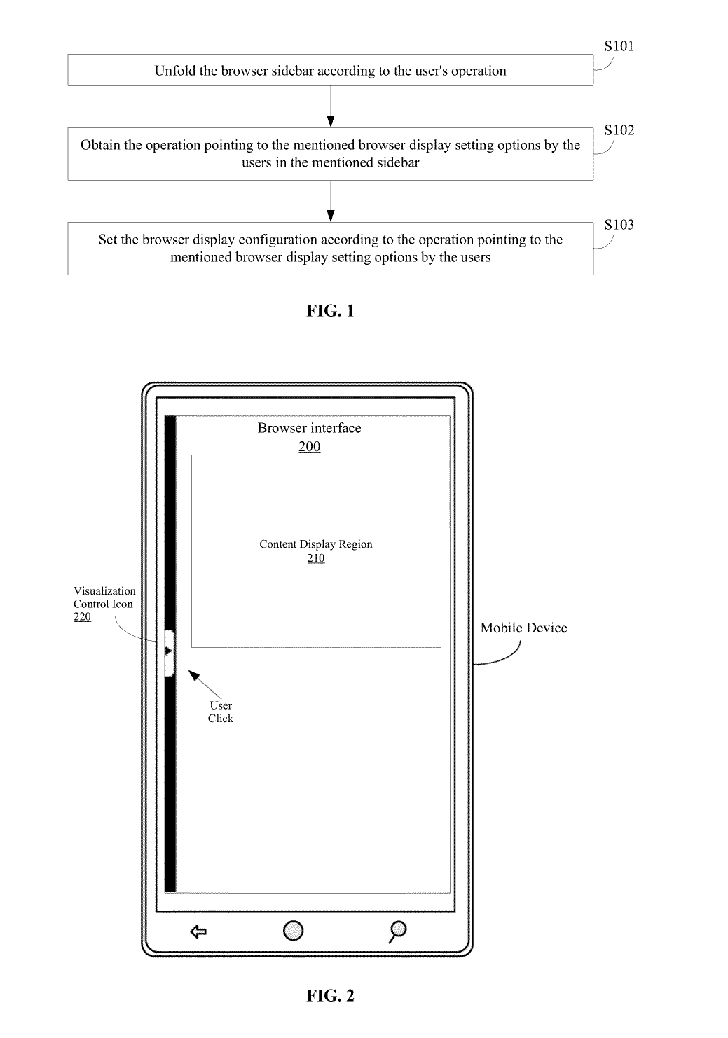

FIG. 1 is the schematic flow diagram of the browser display setting method in the embodiment of the present application, as is shown in the figure, the browser display setting method in this embodiment includes:

S101, unfold the browser sidebar according to the user's operation. In specific realization, browser sidebar can be the state shown in FIG. 2 when it is retracted, when obtaining the user click on the unfold button (e.g., the visualization control icon 220) in sidebar, unfold the browser sidebar, the mentioned browser sidebar included the browser display setting options, which can provide the user with at least one display configuration of browser to set, the mentioned browser display configuration includes the backlight brightness, contrast, display color tone, background image, one or multiple display theme of the browser. In this example, the browser interface 200 is divided into two regions. The visualization control icon 220 is located at the left edge of the browser interface 200 and the content display region 210 is the target of the visualization control icon 220 such that user instructions through the visualization control icon 220 can be applied to the browser application to configure the visualization of the content display region 210. In this example, the configuration of the background image and display theme can be switched in the optional background image and display theme. The mentioned browser display setting options include the configuration adjustment slider, each slider corresponds to a browser display configuration, for example, the backlight brightness, contrast, background image, display color tone and display theme are adjusted respectively by one slider accordingly; the mentioned display setting options of browser can also include at least one group of configuration adjustment increase/decrease button, each group of configuration adjustment increase/decrease button corresponds to a browser display configuration, for example, the backlight brightness, contrast, background image, display color tone and display theme are adjusted respectively by one group of configuration adjustment increase/decrease button accordingly. It should be noted that the above mentioned configuration adjustment slider and configuration adjustment increase/decrease button are only two demonstration implementation modes of the present application, the technicians in this field can obtain other implementation modes of the browser display setting options under the elicitation of the core notion of the present application.

S102, obtain the operation pointing to the mentioned browser display setting options by the users in the mentioned sidebar. For example, obtain the trigger operation of the users for the mentioned configuration adjustment slider, move the mentioned configuration adjustment slider, or receive the user's trigger operation to the mentioned configuration adjustment increase/decrease button.

S103, set the browser display configuration according to the operation pointing to the mentioned browser display setting options by the users. In specific realization, the browser or the browser display setting device can call the API (Application Programming Interface) corresponding to the terminal operation system and set the display configuration of the terminal screen according to the obtained operation pointing to the mentioned browser display setting options by the users, for example, obtain the operation pointing to the contrast of browser by the users in the sidebar to call the API of setting screen display contrast provided by terminal operation system according to the setting option of the contrast, and sets the display contrast of the terminal screen according to the users' operation, such as increasing the contrast by 5%, or setting as the contrast target value input by the users. Optionally, the display configuration of setting the browser in the embodiment of the present application can be effective to all the pages in the browser, for example, after setting the brightness of terminal screen, it is unnecessary to reset when closing or switching the current page, and the original display configuration of the operation system can resume when the browser signs out or the user switches into another functional interface.

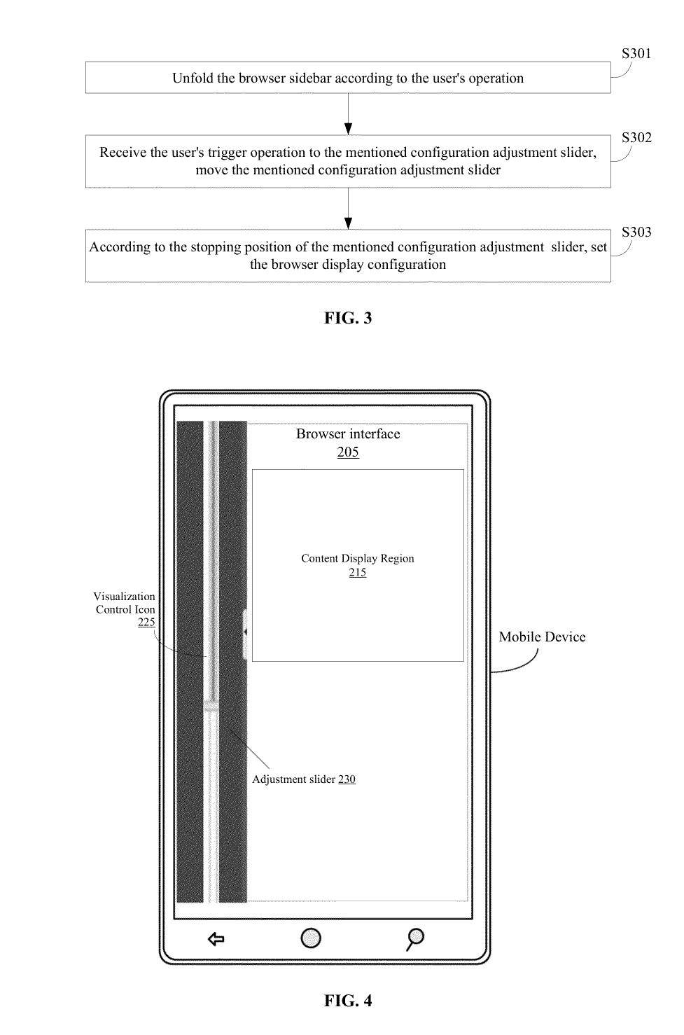

FIG. 3 is the schematic flow diagram of browser display setting method provided by another embodiment of the present application. As shown in the figure, the browser display setting method of the present application includes:

S301, unfold the browser sidebar according to the user's operation. In specific realization, the mentioned browser sidebar includes browser display setting options, the browser display setting options of this embodiment include the configuration adjustment slider shown in FIG. 4, this embodiment can take the brightness adjustment slider 230 as an example.

S302, receive the user's trigger operation to the mentioned configuration adjustment slider, move the mentioned configuration adjustment slider. In specific realization, the user can make the slider move to the desired location by dragging the slider on the touch screen or clicking the effective area of the slide area.

S303, according to the stopping position of the slider, set the browser display configuration. In specific realization, according to the user's operation of moving the brightness adjustment slider, it can call the brightness adjustment API in the operating system to perform the brightness adjustment settings for the terminal screen, and then set the screen backlight brightness according to the proportion of stopping position of the slider in the slide area, e.g., the length proportion that the area below the stopping position of slider takes up the whole slide area in FIG. 4, if the length proportion of the stopping position of brightness adjustment slider in FIG. 4 is 40%, the set screen backlight brightness is 40% of the highest brightness value supported by the terminal. In other embodiments, other display configurations of browser can be set by configuration adjustment slider, such as contrast, background images, display color tone and display themes, and repeated description is avoided.

In this example, the browser interface 200 in FIG. 2 transitions to the browser interface 205 in FIG. 4. Because of the user click on the visualization control icon 220 shown in FIG. 2, the visualization control icon 220 is expanded from its default dimension as shown in FIG. 2 into the content display region. As shown in FIG. 4, the expanded visualization control icon 225 includes an adjustment slider 230 for adjusting the visualization of the content display region 215. When the user slides the adjustment slider 230, the mobile device updates the visualization of the content display region 235 in accordance with the user instructions. In some embodiments, the expanded visualization control icon retracts to its original position as shown in FIG. 2 and returns to the default dimension. As shown in FIG. 4, when the mobile device expands the visualization control icon, the content display region 235 is shifted to the right in accordance with the expansion of the visualization control icon. In some embodiments, the visualization control icon shown in FIG. 2 does not stay on the display of the mobile device forever. After the user has used the visualization control icon to adjust the display of the content display region, the visualization control icon first returns to its original position and then completely disappears from the web browser interface after a predefined time period (e.g., a minute). But when the web browser is shut down and restarted, the visualization control icon then shows up again on the display. In some embodiments, the visualization control icon is brought back to the display whenever the user visits a new website. As noted above, the user may be able to use the visualization control icon to control one or more display attributes of the content display region including brightness, contrast, background color, and color tone of the content display region. Unlike the conventional approach, because the user instructions are applied to the content display region through an application programming interface of the web browser application, the visualization control icon only affects the look and feel of the web browser application but not to another application. This feature makes it possible for the user to choose different visualization configurations for different applications, which is not a “one-size-fitting-all” solution. Moreover, because the visualization control icon is displayed next to the content display region, the user can instantly tell the adjustment results without having to switch back and forth between the content display region (i.e., the target of the display configuration) and the conventional display configuration setting page.

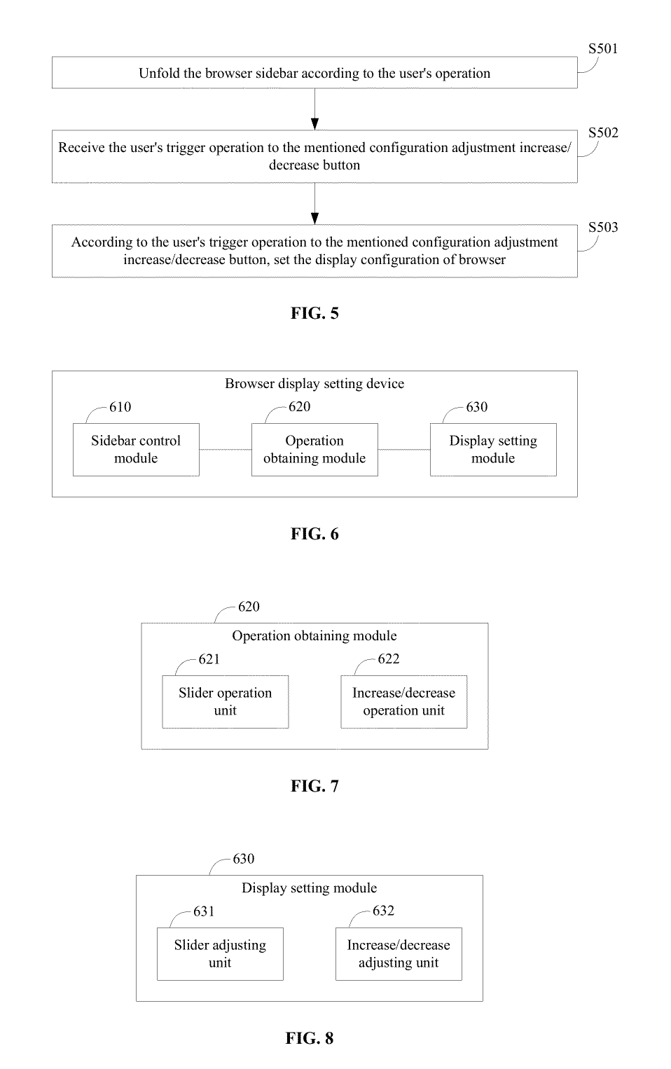

FIG. 5 is the schematic flow diagram of the browser display setting method in another embodiment of the present application, as is shown in the figure, the browser display setting method in the present embodiment can include:

S501, unfold the browser sidebar according to the user's operation. In specific realization, the mentioned browser sidebar include browser display setting options, the browser display setting options of the present embodiment include at least one group of configuration adjustment increase/decrease button, each group of configuration adjustment increase/decrease button corresponds to a browser display configuration, for example, the backlight brightness, contrast, background image, display color tone and display theme are adjusted respectively by one group of configuration adjustment increase/decrease button accordingly.

S502, receive the user's trigger operation to the mentioned configuration adjustment increase/decrease button.

S503, according to the user's trigger operation to the mentioned configuration adjustment increase/decrease button, set the display configuration of browser. In specific realization, according to the user's trigger operation of clicking the mentioned configuration adjustment increase/decrease button, it can call the API corresponding to operating system to adjust the display configuration of terminal screen, taking the configuration adjustment increase/decrease button for the adjustment of screen brightness as an example, it can averagely set several levels between the minimum brightness value and the maximum brightness value which are supported by terminal, such as 10 levels, and thus every time users clicking the brightness increase button once is obtained, it shall set the screen backlight brightness to increase one level correspondingly, otherwise, every time users clicking the brightness decrease button once is obtained, it shall set the screen backlight brightness to decrease one level correspondingly. In other embodiments, other display configurations of browser can be set by configuration adjustment increase/decrease button, such as contrast, background images, display color tone and display themes, and repeated description is avoided.

FIG. 6 is the schematic diagram showing the structure of a browser display setting device of the embodiment for the present application, as is shown in the figure, the browser display setting device of the embodiment for the present application can include at least:

Sidebar control module 610, configure to unfold the browser sidebar according to the user's operation, the mentioned browser sidebar included the browser display setting options. In specific realization, browser sidebar can be the state shown in FIG. 2 when it is retracted, when obtaining the user clicking the unfold button in sidebar, Sidebar control module 610 unfolds the browser sidebar, the mentioned browser sidebar included the browser display setting options, which can provide the user with at least one display configuration of browser to set, the mentioned browser display configuration includes the backlight brightness, contrast, display color tone, background image, one or multiple display theme of the browser. In this example, the configuration of the background image and display theme can be switched in the optional background image and display theme. The mentioned browser display setting options include the configuration adjustment slider, each slider corresponds to a browser display configuration, for example, the backlight brightness, contrast, background image, display color tone and display theme are adjusted respectively by one slider accordingly; the mentioned display setting options of browser can also include at least one group of configuration adjustment increase/decrease button, each group of configuration adjustment increase/decrease button corresponds to a browser display configuration, for example, the backlight brightness, contrast, background image, display color tone and display theme are adjusted respectively by one group of configuration adjustment increase/decrease button accordingly. It should be noted that the above mentioned configuration adjustment slider and configuration adjustment increase/decrease button are only two demonstration implementation modes of the present application, the technicians in this field can obtain other implementation modes of the browser display setting options under the elicitation of the core notion of the present application.

Operation obtaining module 620, configured to obtain the operation pointing to the mentioned browser display setting options by the users in the mentioned sidebar. As shown in FIG. 7, operation obtaining module 620 of the embodiment for the present application can further include:

Slider operation unit 621, configured to receive the user's trigger operation to the mentioned configuration adjustment slider, move the mentioned configuration adjustment slider. In specific realization, slider operation unit 621 can control the slider to move to the desired location of the slide area according to the operation of dragging the slider on the touch screen or clicking the effective area of the slide area.

Increase/decrease operation unit 622, configured to receive the user's trigger operation to the mentioned configuration adjustment increase/decrease button.

Display setting module 630, configured to set the browser display configuration according to the operation pointing to the mentioned browser display setting options by the users. In specific realization, display setting module 630 can call the API corresponding to terminal operation system to set the display configuration of terminal screen according to the operation pointing to the mentioned browser display setting options by the users which is obtained in operation obtaining module 620. For example, operation obtaining module 620 obtains the operation pointing to the setting option of the contrast of browser by the users in the sidebar, and thus display setting module 630 calls the API of setting screen display contrast provided by terminal operation system according to the setting option of the contrast, and sets the display contrast of the terminal screen according to the users' operation, such as increasing the contrast by 5%, or setting as the contrast target value input by the users. Optionally, the display configuration of setting the browser in the embodiment of the present application can be effective to all the pages in the browser, for example, after setting the brightness of terminal screen, it is unnecessary to reset when closing or switching the current page, and the original display configuration of the operation system can resume when the browser signs out or the user switches into another functional interface. As shown in FIG. 8, the display setting module 630 of the embodiment for the present application can further include:

Slider adjusting unit 631, configured to set the browser display configuration according to the stopping position of the slider. Taking the brightness adjustment slider for the adjustment of screen brightness as an example, according to the user's operation of moving the brightness adjustment slider, slider adjusting unit 631 can call the brightness adjustment API in the operating system to perform the brightness adjustment settings for the terminal screen, and then set the screen backlight brightness according to the proportion of stopping position of the slider in the slide area, e.g., the length proportion that the area below the stopping position of slider takes up the whole slide area in FIG. 4, if the length proportion of the stopping position of brightness adjustment slider in FIG. 4 is 40%, the set screen backlight brightness is 40% of the highest brightness value supported by the terminal. In other embodiments, slider adjusting unit 631 can set other display configurations of browser by configuration adjustment slider, such as contrast, background images, display color tone and display themes, and repeated description is avoided.

Increase/decrease adjusting unit 632, configured to set the display configuration of browser according to the user's trigger operation to the mentioned configuration adjustment increase/decrease button. In specific realization, according to the user's trigger operation to the mentioned configuration adjustment increase/decrease button, the slider adjusting unit 631 can call the API corresponding to the operating system to adjust the display configuration of terminal screen, taking the configuration adjustment increase/decrease button for the adjustment of screen brightness as an example, it can averagely set several levels between the minimum brightness value and the maximum brightness value which are supported by terminal, such as 10 levels, and thus every time users clicking the brightness increase button once is obtained, it shall set the screen backlight brightness to increase one level correspondingly, otherwise, every time users clicking the brightness decrease button once is obtained, it shall set the screen backlight brightness to decrease one level correspondingly. In other embodiments, other display configurations of browsers can be set by configuration adjustment increase/decrease button, such as contrast, background images, display color tone and display themes, and repeated description is avoided.

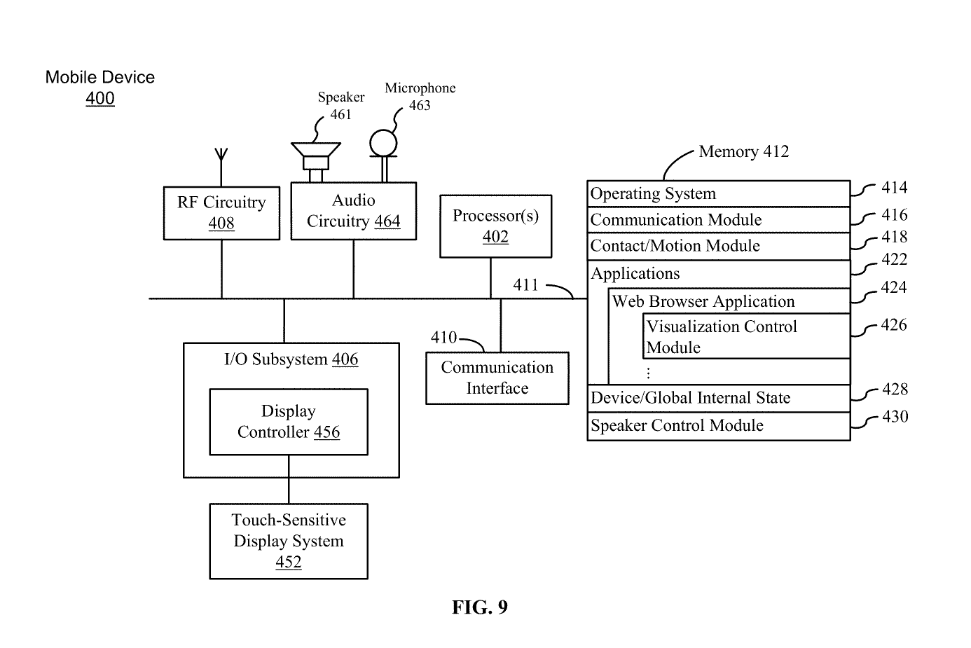

FIG. 9 is a block diagram illustrating components of a mobile device 400 with a touch-sensitive display system 452 in accordance with some embodiments of the present application. The mobile device 400 may include memory 412 (which may include one or more computer readable storage mediums), one or more processors 402, audio circuitry 464, speaker 461, microphone 463, input/output (I/O) subsystem 406, and RF (radio frequency) circuitry 408. These components may communicate over one or more communication buses 411.

Memory 412 may include high-speed random access memory and may also include non-transitory computer readable storage medium, such as one or more magnetic disk storage devices, flash memory devices, or other non-volatile solid-state memory devices. The one or more processors 402 run or execute various software programs and/or sets of instructions stored in memory 412 to perform various functions for the mobile device 400 and to process data.

RF circuitry 408 converts electrical signals to/from electromagnetic signals and communicates with communications networks and other communications devices via the electromagnetic signals. RF circuitry 408 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 408 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication.

Audio circuitry 464, speaker 461, and microphone 463 provide an audio interface between a user and the mobile device 400. Audio circuitry 464 receives audio data from the communication buses 411, converts the audio data to an electrical signal, and transmits the electrical signal to speaker 461. Speaker 461 converts the electrical signal to human-audible sound waves. Audio circuitry 464 also receives electrical signals converted by microphone 463 from sound waves. Audio circuitry 464 converts the electrical signal to audio data and transmits the audio data to the processors 402 for processing.

I/O subsystem 406 may include a display controller 456 for controlling the touch-sensitive display 452 to implement, e.g., virtual or soft buttons and one or more soft keyboards. The touch-sensitive display 452 provides an input interface and an output interface between the device and a user. Display controller 456 receives and/or sends electrical signals from/to touch screen 452. Touch screen 452 displays visual output to the user. The visual output may include graphics, text, icons, video, and any combination thereof (collectively termed “graphics”). In some embodiments, some or all of the visual output may correspond to user-interface objects.

Touch screen 452 has a touch-sensitive surface, sensor or set of sensors that accepts input from the user based on haptic and/or tactile contact. Touch screen 452 and display controller 456 (along with any associated modules and/or sets of instructions in memory 402) detect contact (and any movement or breaking of the contact) on touch screen 452 and converts the detected contact into interaction with user-interface objects (e.g., one or more soft keys, icons, web pages or images) that are displayed on touch screen 452.

In some embodiments, the software components stored in memory 412 include operating system 414, communication module (or set of instructions) 416, contact/motion module (or set of instructions) 418, and applications (or sets of instructions) 422. Furthermore, in some embodiments memory 412 stores device/global internal state 428 including one or more of: active application state, indicating which applications, if any, are currently active; display state, indicating what applications, views or other information occupy various regions of touch screen display 452; and sensor state, including information obtained from the mobile device's various sensors.

Operating system 414 includes various software components and/or drivers for controlling and managing general system tasks (e.g., memory management, storage device control, power management, etc.) and facilitates communication between various hardware and software components. Communication module 416 facilitates communication with other devices over the communication buses 411 and also includes various software components for handling data received by RF circuitry 408. Contact/motion module 418 may detect contact with touch screen 452 (in conjunction with the display controller 456) and motions by the contact. Contact/motion module 418 includes various software components for performing various operations related to detection of contact, such as determining if contact has occurred (e.g., detecting a finger-down event), determining if there is movement of the contact and tracking the movement across the touch-sensitive surface (e.g., detecting one or more finger-dragging events), and determining if the contact has ceased (e.g., detecting a finger-up event or a break in contact). Applications 422 may include the following applications (or sets of instructions), or a subset or superset thereof: web browser application 424 that further includes a visualization control module 426 as described above in connection with FIGS. 1-8.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various embodiments. Through the description of the exemplary embodiments, in the present application, the play mode of the mobile device is controlled by associating the position status of the mobile device with the distance between the mobile device and the user. Because the influence imposed on the position status of the mobile device by the operation of the user on the mobile device is considered together with the distance between the mobile device and the user, the play mode of the mobile device can be controlled more accurately and effectively to meet the user's actual requirements for the play mode, thereby avoiding unnecessary operations and improving the intelligence of the mobile device.

Persons of ordinary skill in the art may understand that all or a part of the flow of the method according to the embodiments may be implemented by a program instructing relevant hardware. The program may be stored in a computer readable storage medium. When the program is executed, the flow of the embodiment of the foregoing method may be included. The storage medium may be a magnetic disk, an optical disk, a read-only memory (Read-Only Memory, ROM) or a random access memory (Random Access Memory, RAM) and the like.

The embodiment of the present application can set quickly the display configuration of browser through browser display setting option in browser sidebar, through which user's eyesight can be protected effectively, and better browsing effect can be achieved.

The common technicians of this field can understand that the realization of all of or part of steps of the aforementioned embodiment can be done through controlling relevant hardware by computer program command (e.g. the program command corresponding to the aforementioned browser display setting device), and the mentioned program command can be stored in computer readable storage media, for example, storage media of tablets, mobile phone, smart phone, laptop and other mobile device devices through which browser display setting device of embodiment of the present application can be realized, and quick setting of display configuration of browser can be realized through at least one processor of this mobile device to perform. In this embodiment, this processor includes such flow as the aforementioned embodiments of each method during performing the mentioned program commands.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the present application to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

What is claimed is:

1. A method for configuring visualization of an application, comprising:
at a mobile device having one or more processors and memory and a display:
displaying an application on the display, the application including a content display region and a visualization control icon at a default dimension;
detecting a user selection of the visualization control icon;
in response to detecting the user selection:
expanding the visualization control icon into the content display region, the expanded visualization control icon including a region for receiving one or more user instructions;
updating the visualization of the content display region in accordance with the user instructions; and
reducing the expanded visualization control icon to its default dimension.

2. The method of claim 1, further comprising:
while expanding the visualization control icon:
shifting the content display region on the display in accordance with the expansion of the visualization control icon.

3. The method of claim 1, wherein the visualization control icon is configured to completely disappear from the application on the display after a predefined time period from the reduction of the expanded visualization control icon to its default dimension.

4. The method of claim 1, wherein updating the visualization of the content display region further includes changing at least one attribute selected from the group consisting of brightness, contrast, background color, and color tone of the content display region.

5. The method of claim 1, wherein the visualization of the content display region is updated by invoking an application programming interface of the application and applying the user instructions to the content display region through the application programming interface.

6. The method of claim 1, wherein the visualization control icon is configured to only affect the visualization of the application but not another application.

7. The method of claim 1, wherein the expanded visualization control icon is reduced to its default dimension after a predefined time period from receiving the user instructions.

8. The method of claim 1, wherein the region for receiving one or more user instructions is one selected from the group consisting of a scroll bar and a pair of increase and decrease buttons.

9. The method of claim 1, wherein the application is a web browser application.

10. A mobile device, comprising:
one or more processors;
memory;
a display; and
one or more programs stored in the memory and to be executed by the one or more processors, the one or more programs further including instructions for:
displaying an application on the display, the application including a content display region and a visualization control icon at a default dimension;
detecting a user selection of the visualization control icon;
in response to detecting the user selection:
expanding the visualization control icon into the content display region, the expanded visualization control icon including a region for receiving one or more user instructions;
updating the visualization of the content display region in accordance with the user instructions; and
reducing the expanded visualization control icon to its default dimension.

11. The mobile device of claim 10, wherein the one or more programs further include instructions for:
while expanding the visualization control icon:
shifting the content display region on the display in accordance with the expansion of the visualization control icon.

12. The mobile device of claim 10, wherein the visualization control icon is configured to completely disappear from the application on the display after a predefined time period from the reduction of the expanded visualization control icon to its default dimension.

13. The mobile device of claim 10, wherein updating the visualization of the content display region further includes changing at least one attribute selected from the group consisting of brightness, contrast, background color, and color tone of the content display region.

14. The mobile device of claim 10, wherein the visualization of the content display region is updated by invoking an application programming interface of the application and applying the user instructions to the content display region through the application programming interface.

15. The mobile device of claim 10, wherein the visualization control icon is configured to only affect the visualization of the application but not another application.

16. The mobile device of claim 10, wherein the expanded visualization control icon is reduced to its default dimension after a predefined time period from receiving the user instructions.

17. The mobile device of claim 10, wherein the region for receiving one or more user instructions is one selected from the group consisting of a scroll bar and a pair of increase and decrease buttons.

18. The mobile device of claim 10, wherein the application is a web browser application.

19. A non-transitory computer readable storage medium having stored therein one or more programs for execution by a mobile device having one or more processors and a display, the one or more programs further including instructions for:
displaying an application on the display, the application including a content display region and a visualization control icon at a default dimension;
detecting a user selection of the visualization control icon;
in response to detecting the user selection:
expanding the visualization control icon into the content display region, the expanded visualization control icon including a region for receiving one or more user instructions;
updating the visualization of the content display region in accordance with the user instructions; and
reducing the expanded visualization control icon to its default dimension.

20. The non-transitory computer readable storage medium of claim 19, wherein the one or more programs further include instructions for:
while expanding the visualization control icon:
shifting the content display region on the display in accordance with the expansion of the visualization control icon.
